(19) United States
(12) Patent Application Publication
(10) Pub. No.: US 2002/0015453 A1
(43) Pub. Date: Feb. 7, 2002

(54) Receiver and method of receiving for an FDMA/TDMA radio system

(76) Inventor: Kevin Lamacraft, Twickenham (GB)

Correspondence Address: Michael B. Lasky, Altera Law Group, 6500 City West Parkway - Suite 100, Minneapolis, MN, 55344-7701, US

(21) Appl. No.: 09/871,841

(22) Filed: Jun. 1, 2001

Related U.S. Application Data
(63) Continuation of application No. PCT/GB99/03947, filed on Nov. 26, 1999.

(30) Foreign Application Priority Data
Dec. 3, 1998 (GB) 9826665.3

(51) Int. Cl. H04L 27/06; H04L 27/14; H04L 27/22

(52) U.S. Cl. 375/316

(57) ABSTRACT

A receiver which comprises means for receiving a first plurality of signals at different frequencies at the same time, means for generating a second plurality of signals (116), a mixer (114) for receiving, at the same time, the first plurality of signals at different frequencies and one of the second plurality of signals at a time wherein the second plurality of signals are mixed by the mixer (114) in succession, said first plurality of signals being mixed with successive ones of the second plurality of signals and filter means (320) for mixing signals output from said mixer (114), said filter means (120) being arranged to provide a series of samples of the first plurality of signals at the same frequency, wherein each of the said samples are separated in time.

### FIELD OF INVENTION

The present invention relates to a receiver and a method of receiving and, in particular but not exclusively, for use in a wireless cellular telecommunication network.

### BACKGROUND TO THE INVENTION

A typical known wireless telecommunications cellular network will now be described with reference to FIG. 1. The area covered by the network 2 is divided into a plurality of cells 4. Each cell 4 is served by a base transceiver station 6 which is arranged to transmit signals to and receive signals from terminals located in the cell 4 associated with the respective base transceiver station 6. The terminals 8 may be mobile stations which are able to move between the cells 4.

Each base transceiver station is, in the GSM standard (Global System for Mobile Communications), arranged to receive N out of M available channels C1 . . . CM as illustrated in FIG. 2. The GSM standard uses a frequency division multiple access technique. Each channel has a bandwidth of 200 KHz. Each bandwidth is divided into frames F one of which is shown in FIG. 3. Each frame is divided into eight slots T0 . . . T7. The GSM standard is a time division multiple access (TDMA) system and accordingly different mobile stations will be allocated different time slots for a given frequency. Thus, the base transceiver station will receive signals from different mobile stations in different time slots at the same frequency.

Reference is made to FIG. 7 which shows part of a known base transceiver station 9 which is arranged to receive N channels at the same time. For clarity, only the receiving part of the base transceiver station 9 is shown. The base transceiver station 9 has an antenna 10 which is arranged to receive signals from mobile stations in the cell served by the base transceiver station 9. The base transceiver station comprises N receivers R1 R2 . . . RN. Thus one receiver is provided for each channel which is to be received by the base station 9 at the same time. All of the receivers R1-RN are the same and accordingly the components of the first receiver R1 only are shown.

The first receiver R1 comprises a first bandpass filter 12 which is arranged to filter out signals which fall outside the receive band in which the M available channels are located. The filtered output is input to a first low noise amplifier 14 which amplifies the received signals. The amplified signal is then passed through a second bandpass filter 14 which filters out any noise, such as harmonics or the like introduced by the first amplifier 14. The output of the second bandpass filter is connected to a mixer 18 which receives a second input from a local oscillator 20. The frequency of the output of the local oscillator 20 will depend on the frequency of the channel allocated to the particular receiver. The output of the second bandpass filter 16 is mixed with the output of the local oscillator 20 to provide a signal at an intermediate frequency IF, which is less than the radio frequency at which the signals are received. The intermediate frequency IF output by the mixer 18 of each receiver will be the same for all receivers and may, for example, be 180 MHz. For example, if the channel allocated to a given receiver has a frequency of 880 MHz then the local oscillator 20 of that receiver will be tuned to 700 MHz. On the other hand, if the channel allocated to a given receiver has a frequency of 900 MHz, then the local oscillator will be tuned to a frequency of 720 MHz.

The output of the mixer 18 is input to a third bandpass filter 22 which filters out any noise introduced by the mixer 18. The output of the third bandpass filter 22 is amplified by a second amplifier 24 and output to a surface acoustic wave (SAW) filter 26. The surface acoustic wave filter 26 applies filtering to all interfering signals except that of the channel allocated to that particular receiver. In other words, all the channels received by the antenna 10 with the exception of the channel allocated to the receiver will be filtered by the surface acoustic wave filter 26. The output of the surface acoustic wave filter 26 is connected to an automatic gain control unit 28 which alters the gain of the signal so that it falls within the dynamic range of an analogue to digital converter 30.

One problem with the known architecture is that it is necessary to provide a receiver for each channel. This is to ensure that each signal which is input to an analogue to digital converter is within the dynamic range of that converter. The need to provide a receiver for each channel increases substantially the costs of the base transceiver station. It is therefore an aim of embodiments of the present invention to address this problem.

### SUMMARY OF THE INVENTION

According to one aspect of the present invention, there is provided a receiver comprising means for receiving a first plurality of signals at different frequencies at the same time; means for generating a second plurality of signals, a mixer for receiving at the same time, the first plurality of signals at different frequencies and one of the second plurality of signals at a time wherein the second plurality of signals are received by the mixer in succession, said first plurality of signals being mixed with successive ones of the second plurality of signals; and filter means for receiving signals output from said mixer, said filter means being arranged to provide a series of samples of the first plurality of signals at the same frequency, wherein each of the said samples are separated in time.

Thus, it is possible to provide a single receiver which is able to deal with a number of signals at different frequencies, which may be different channels. Accordingly, the number of components which are required may be reduced as compared to the known receivers. As the samples are spaced apart in time, this makes it possible to provide a receiver in which, for example, the magnitude of each individual signal can be altered in order to allow the signals always to be within the dynamic range of a given element, such as an analogue to digital converter.

The reducing means may be arranged to produce a plurality of sets of samples, each set of samples comprising one sample for each of the first plurality of signals.

Each of the first plurality of signals may have a plurality of bits and the reducing means is preferably arranged to generate a set of samples in a period equal to or less than the period of one bit of said first plurality of signals. In this way, no information carried by the signals is lost.

The generating means preferably comprises a direct digital synthesiser. Preferably, the generating means is arranged to generate each of the second plurality of signals in turn.

The generating means may be arranged to generate signals and then to increase the frequency thereof to provide said second plurality of signals. This is advantageous where the generating means is unable to provide signals of a high enough frequency for use in a particular receiver. The generating means may comprise multiplier means for increasing the frequency of the generated signals in order to provide the second plurality of signals. Alternatively, the generating means may utilise the harmonics of the generated signals to provide the second plurality of signals. In yet another alternative, the generating means may comprise means for adding the generated signals to a further signal, for example from a synthesiser, to provide said second plurality of signals.

Preferably, the first plurality of signals are reduced by said reducing means to the same frequency. This makes it easier for components downstream of the reducing means to process the received signals. The reducing means may comprise filter means for filtering out those of the first plurality of signals which after reducing are not at the same frequency. This allows the series of samples to be provided.

A base station preferably includes a receiver as defined hereinbefore. Preferably, the base station uses a time division multiple access system.

According to a second aspect of the present invention, there is provided a method of receiving comprising the steps of receiving a first plurality reducing the frequency of the first plurality of signals be mixing the first plurality of signals at different frequencies, at the same time, and one of the second plurality of signals at a time wherein the second plurality of signals are received by the mixer in succession, said first plurality of signals being mixed with successive ones of the second plurality of signals; providing a series of samples, by filtering, of the first plurality of signals at the same frequency, each of said samples being separated in time.

### BRIEF DESCRIPTION OF THE DRAWINGS

For a better understanding of the present invention and as to how the same may be carried into effect, reference will now be made by way of example to the accompanying drawings in which:

FIG. 1 shows a typical wireless cellular telecommunications network;

FIG. 2 shows the channels receivable by base transceiver stations;

FIG. 3 illustrates the structure of a time frame;

FIG. 4 shows a receiver embodying the present invention;

FIG. 5a shows a diagram of the different carrier frequencies received simultaneously;

FIG. 5b illustrates the method of sampling during one bit of one time slot;

FIG. 5c illustrates the control signal;

FIG. 5d illustrates the output of the bandpass filter of FIG. 4;

FIG. 6 illustrates the harmonics provided by the synthesise of FIG. 4; and

FIG. 7 shows a known GSM base transceiver station.

### DETAILED DESCRIPTION OF PREFERRED EMBODIMENTS OF THE INVENTION

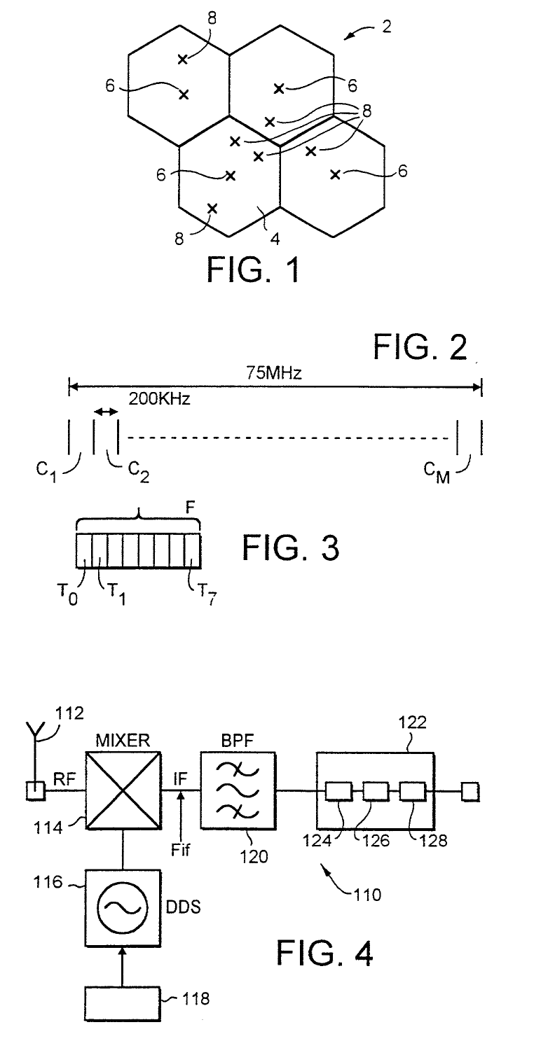

The receiver 110 illustrated in FIG. 4 is incorporated in a base transceiver station for example in a network such as illustrated in FIG. 1. For the purpose of the following description, the receiver 110 will be described in the context of a GSM system. However, it should be appreciated that embodiments of the present invention can be used with any other suitable telecommunications standard.

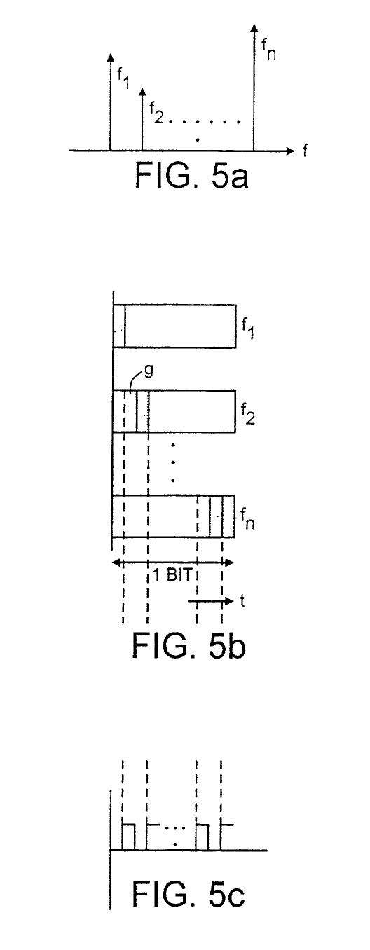

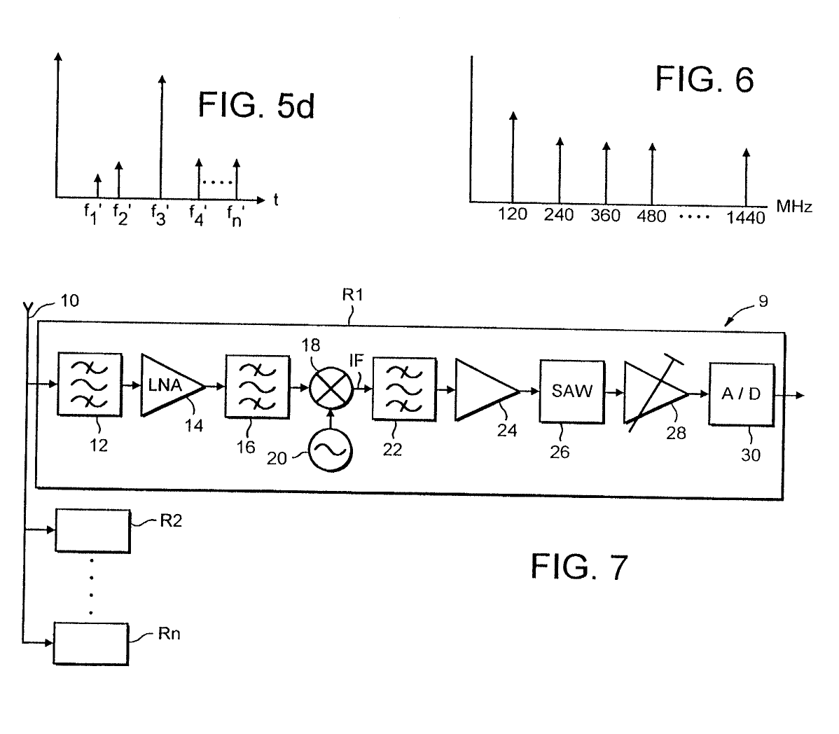

The receiver 110 comprises an antenna 112 which is arranged to receive signals carried by N different carriers. Each of the N different carriers is at a different frequency. In FIG. 5a, the N different carrier frequencies F1-FN are illustrated, each of which is at a radio frequency. Each carrier frequency channel F1-FN has a bandwidth of 200 KHz as in the current GSM standard. Adjacent carrier frequencies F1 . . . FN are spaced apart by at least 600 kHz. The N different carriers and the signals carried thereby are received by the antenna 112. The signals received by the antenna 112 are input to a mixer 114. As with the known receiver illustrated in FIG. 7, the signals may be input first to a bandpass filter, an amplifier and a further bandpass filter. However, these additional components may be omitted in some embodiments of the present invention.

The mixer 114 also receives an input from a direct digital synthesiser 116. The direct digital synthesiser 116 is arranged to frequency hop and provides signals at frequency F1′, F2′ and FN′ in sequence. The frequencies provided by the direct digital synthesiser 116 are arranged for example to satisfy the following criteria:

F1-F1′=F2-F2′= . . . =FN-F′N=K

where K is a constant.

The frequency hopping of the direct digital synthesiser 116 is controlled by a controller 118 which provides a control signal. Each time the control signal changes, for example, from a low level to a high level, the frequency which the direct digital synthesiser 116 produces is changed. Accordingly, in the first control cycle, the digital direct synthesiser 116 will provide signals at frequency F1′, in the next control cycle signals at frequency F2′ will be provided and so on. The control frequency is selected so that each of the N different frequencies F1-FN can be sampled in a time equal to a bit period. The bit period is the length of time for which each bit on each transmitted carrier wave is constant. In other words, the timing of the direct digital synthesiser 116 allows each consecutive bit on each carrier wave to be sampled within one bit period. Thus all of the frequencies F1′ . . . FN′ are produced in turn in a single bit period.

The output of the mixer 114 is connected to a bandpass filter 120 which is tuned to the frequency K. Thus any signals which are not at frequency K are filtered. When the direct digital synthesiser 116 provides a signal at frequency F1′, the signals at frequency F1 are reduced to K. However the signals at frequencies F2′ . . . FN′ are reduced to respective different frequencies which are different to frequency K. Accordingly, when the output of the mixer 114 is input to the bandpass filter 120, only the signal derived from the frequency F1 is output by the filter 120, the other signals being reduced or removed by the filter 120. This process is repeated each time the frequency provided by the synthesiser 116 changes.

Thus as can be seen from FIG. 5b which illustrates the timing of the sampling and FIG. 5c which shows the control signal frequency, the signal initially at frequency F1 is sampled at the beginning of a bit period, the synthesiser being tuned to frequency F1′. When the sampling of the first signal initially at F1 is completed, the direct digital synthesiser 116 is tuned to provide the second frequency F2′. As can be seen from FIG. 5b, it takes the direct digital synthesiser 116 a small amount of time to change from providing the frequency F1′ to providing the frequency F2′. Accordingly, during this period, marked by reference g, no sampling will take place. When the direct digital synthesiser 116 provides the second synthesiser frequency F2′, the signal initially at the second carrier F2 will be sampled. This is carried out for each of the N carrier frequencies F1-FN. The output of the bandpass filter 120 with respect to time is shown in FIG. 5d.

In the current GSM standard, the bit period is 3.69μ seconds. In one embodiment of the present invention, the number of channels and hence different carrier frequencies which will be received at the same time by the base transceiver station will be four. If it is assumed that the guard period and the sampling period are the same, then the direct digital synthesiser 116 will need to hop between the four frequencies required to down convert a respective one of the received channels at a rate of 461 ns. In other words, the time between the ending of one sampling period and the beginning of the next sampling period is be 461 ns and the length of each sampling period will be 461 ns. However, it should be appreciated that it is not essential that the sample and guard times be equal.

The maximum switching speed of currently available direct digital synthesisers 116 is equal to 2/F_{c} where F_{c} is the clock frequency. One commercially available direct digital synthesiser has a clock speed of 300 MHz. This would mean that the maximum switching speed would be 7 ns so the target of 461 ns outlined hereinbefore is clearly possible.

With the current commercially available direct digital synthesisers, the maximum frequency which can be generated is around 40% of the clock frequency. Thus, with a clock speed of 300 MHz, the maximum output frequency would be around 120 MHz. The maximum frequency which will be required will depend on the standard with which the receiver is designed to operate. For example, for one GSM standard, the frequencies required from the synthesiser are around 700 MHz whilst for other standards, higher frequencies of around 1600 MHz would be required.

There are several ways in which this upconversion (in other words the increase in the frequency output by the synthesiser to the required level) can be achieved. The first method is to simply use a multiplier to increase the frequency output by the direct digital synthesiser. The same multiplier can be used to provide the different frequencies. The base frequency output by the synthesiser would then be altered as required. The multiplier would be located between the output of the synthesizer and the input to the mixer. Frequency multipliers are well known and typically comprise a nonlinear circuit which is used to generate a signal at a multiple of the input signal frequency. Whilst multipliers can be used in certain embodiments of the present invention, the signal output by the multiplier includes unwanted noise. In an alternative, the base frequency of the synthesiser remains the same and the factor by which the output of the synthesiser is multiplied by the multiplier is altered in order to obtain the required output frequency for the mixer

A second method is to make use of the fact that the direct digital synthesiser will produce harmonics of the main frequency. In normal use, these harmonics may be removed by filtering. For example, if the main frequency output by the direct digital synthesiser is f then harmonics will be output at 2f, 3f, . . . nf where n is an integer. For example, if the main frequency output by a direct digital synthesiser is 120 MHz, then harmonics will be output at 240 MHz, 360 MHz etc, as illustrated in FIG. 6. If for example a frequency around 1500 MHz were required, then the harmonic at, for example, 1440 MHz could be used. As the harmonics will have a smaller amplitude than the main frequency, an amplifier is required. Additionally, a filter will be required to filter out the unwanted frequencies including the main frequency and the unused harmonics. In order to modify the embodiment shown in FIG. 4 to use this upconversion, an amplifier and filter simply need to be placed between the direct digital synthesiser 16 and the mixer 14. The base frequency from which the harmonics are obtained is altered in accordance with the frequency which is required to be input to the mixer.

In a third method of upconversion, a conventional up conversion technique is used. Thus, the embodiment shown in FIG. 4 would be modified to include one or more mixers between the direct digital synthesiser 116 and the mixer 114. The additional mixer would include one input from the direct digital synthesiser and one input from a fixed frequency synthesiser. The fixed frequency synthesiser would only provide a single frequency and the output of the direct digital synthesiser would be altered to ensure that the correct frequency is output to the mixer. The additional mixer would be arranged to effectively add the two frequencies together to give a higher frequency.

As mentioned hereinbefore, the output of the direct digital synthesiser 116 is mixed with the frequencies received from the antenna 112 by the mixer 114. The mixer 114 reduces the frequencies of the received signals to the intermediate frequency K. The output of the mixer 114 is input to the bandpass filter 120. FIG. 5d shows the typical output of the bandpass filter 120. The output of the bandpass filter 120 provides an instantaneous value for each bit of a signal with each value being spaced from one another.

The filtered output of the bandpass filter 120 is input to an analogue to digital converter and digital signal processor block 122. The processor block 122 comprises an automatic gain control block 124 connected to the output of the bandpass filter. This automatic gain control block 124 controls the gain of the signal output by the bandpass filter 120 so that the signal has an amplitude falling within a predetermined range. That range is preferably the dynamic range of the analogue to digital converter block in the processor 122. The output of the automatic gain control block is input to an analogue to digital converter 126 which also forms part of the processor 122. The signal from the automatic gain control block 124, which is in analogue form, is converted to digital form.

The output of the analogue to digital converter 126 is connected to and processed by a digital signal processor 128 of the processor 122 in a manner which is generally known in the art and accordingly will not be described in any further detail hereinafter. In general, the digital signal processor extracts the data from the carrier waves.

Currently available digital signal processors and analogue to digital converters are capable of extracting phase information from a carrier that exists for one bit in one phase state for around 48 cycles of the carrier frequency per phase state. In the embodiment shown in FIG. 4, if the intermediate frequency, for example 170 MHz is sampled by the analogue to digital converter of the unit 122 for a duration of 461 ns, there would be 78 cycles of the frequency per phase state. Clearly, known digital signal processors would be able to deal with this.

It should be noted that in some embodiments of the present invention, it may not be necessary to upconvert the output of the direct digital synthesiser. This may be if relatively low frequency is required from the direct digital synthesiser. It is also envisaged that developments will occur which will permit direct digital synthesisers to provide higher frequencies.

In the described embodiments, a single receiver which is able to deal with all the channels is described. However, in one modification, a plurality of receivers is provided and each receiver is arranged to deal with a plurality of channels.

In the embodiment described hereinbefore, it is assumed that the signals which are received by the base station have synchronised timing so that the bit periods in each channel are synchronised. However in other embodiments of the invention, the channels need not be synchronised.

Whilst embodiments of the present invention have been described in relation to a GSM system, embodiments of the present invention can be used with any other suitable standard including analogue standards, other standards using time division multiple access (TDMA), spread spectrum systems such as code division multiple access (CDMA), frequency division multiple access (FDMA), space division multiple access (SDMA) and hybrids of any of these systems.

Embodiments of the present invention have been described in the context of a receiver for a base transceiver station. However, embodiments of the present invention can be used in any other suitable receiver such as in a mobile station as well as in other types of receiver which are not used in cellular networks but which are arranged to receive a number of signals, at different frequencies, at the same time. Other applications include multicarrier power control for transmitters.

1. A receiver comprising:
means for receiving a first plurality of signals at different frequencies at the same time;
means for generating a second plurality of signals, a mixer for receiving at the same time, the first plurality of signals at different frequencies and one of the second plurality of signals at a time wherein the second plurality of signals are received by the mixer in succession, said first plurality of signals being mixed with successive ones of the second plurality of signals; and filter means for receiving signals output from said mixer, said filter means being arranged to provide a series of samples of the first plurality of signals at the same frequency, wherein each of the said samples are separated in time.

2. A receiver as claimed in claim 1, wherein said reducing means is arranged to produce a plurality of sets of samples, each set of samples comprising one sample for each of said first plurality of signals.

3. A receiver as claimed in claim 1,2 or 3, wherein each of said first plurality of signals has a plurality of bits and the reducing means is arranged to generate a set of samples in a period equal to or less than the period of one bit of said first plurality of signals.

4. A receiver as claimed in any preceding claim, wherein said generating means comprises a direct digital synthesiser.

5. A receiver as claimed in any preceding claim, wherein the generating means is arranged to generate each of said second plurality of signals in turn.

6. A receiver as claimed in any one of the preceding claims, wherein the generating means is arranged to generate signals and then to change the frequency thereof to provide said second plurality of signals.

7. A receiver as claimed in claim 6, wherein the generating means comprise multiplier means for increasing the frequency of the generated signals to provide the second plurality of signals.

8. A receiver as claimed in claim 6, wherein the generating means utilises harmonics of said generated signals to provide said second plurality of signals.

9. A receiver as claims in claim 6, wherein the generating means comprises means for adding said generated signals to a further signal to provide said second plurality of signals.

10. A receiver as claimed in any one of the preceding claims, wherein the first plurality of signals are reduced by said reducing means so that the series of samples are at the same frequency.

11. A receiver as claimed in claim 10, wherein the reducing means comprises filter means for filtering out those of the plurality of first signals which after reducing are not at said same frequency.

12. A receiver as claimed in any preceding claim, wherein the reducing means comprises mixer means.

13. A base station incorporating a receiver as claimed in any preceding claim.

14. A base station as claimed in claim 13, wherein a time division multiple access system is used by said base station.

15. A method of receiving comprising the steps of:
receiving a first plurality of signals at different frequencies;
generating a second plurality of signals;
reducing the frequency of the first plurality of signals by mixing the first plurality of signals at different frequencies at the same time, and one of the second plurality of signals at a time wherein the second plurality of signals are received by the mixer in succession, said first plurality of signals being mixed with successive ones of the second plurality of signals; providing a series of samples by filtering of the first plurality of signals at the same frequency, each of said samples being separated in time.
